(19) United States
(12) Patent Application Publication
(10) Pub. No.: US 2004/0029083 A1
(43) Pub. Date: Feb. 12, 2004

(54) Phonemically organized keyboard attached to a speech synthesizer: a machine for teaching the sounds of the letters to young children

(76) Inventor: Edmund Benedict Coleman, El Paso, TX (US)

Correspondence Address: Edmund Benedict Coleman, 1001 E. Baltimore Dr., El Paso, TX, 79902, US

(21) Appl. No.: 10/212,158

(22) Filed: Aug. 6, 2002

(51) Int. Cl. G09B 1/00; G09B 19/00

(52) U.S. Cl. 434/167; 434/169; 434/362

(57) ABSTRACT

The letters on this Teaching Keyboard are re-positioned into dimensions that parallel the dimensions of their phonemes; i.e., phonemes that are articulated similarly /k-g/, or have similar functions in spelling, are in adjacent keys, which are sequenced down the keyboard to indicate place of articulation (front-middle-back of mouth). The board has new keys for silent markers (a, e, i-y). Moreover, these keys are programmed to print silent markers in outline or in gray (raid, ray), thus differentiating them from ordinary letters that signal sounds. The keyboard has new letters for the phonemes spelled with h (ch-sh-th). To reduce the most frequent confusions among letters, b-q-l-i were changed a trifle, becoming [symbol] -qu-L- [symbol] . The keyboard lengthens protrusions on letters like d and y to increase differences between the outer contours of word shapes.

### CROSS-REFERENCE TO RELATED APPLICATIONS

Not Applicable

### STATEMENT REGARDING FEDERALLY SPONSORED RESEARCH OR DEVELOPMENT

The research and development of this keyboard was not federally supported. I did it on my own after I retired. REFERENCE TO SEQUENCE LISTING, A TABLE, OR A COMPUTER PROGRAM LISTING COMPACT DISK APPENDIX

Not Applicable. No material is submitted on a compact disk.

### BACKGROUND OF THE INVENTION

The field of endeavor is teaching young children to read. The invention is a keyboard to be used during the first year of reading instruction; it aids in teaching the sounds of the letters. The most appropriate ages are 5- and 6-year-olds.

My description of prior art will be discussed under four sub-headings: (A) Phonemic Organization in Korea's Alphabet, Hangul, (B) Spelling Irregularity and the Initial Teaching Alphabet, (C) Most Frequently Confused Letters, (D) Lengthening Upward and Downward Protrusions to increase the difference in outer contours of words.

(A) Phonemic Organization in Korea's Alphabet, Hangul. The idea for phonemic organization came from Korea's remarkable alphabet, Hangul. It is the only alphabet throughout the five thousand year history of writing whose letters were designed to parallel the structure of its spoken phonemes. All spoken languages are organized into a tiny handful of dimensions such as manner of articulation, place of articulation, voiced vs. unvoiced. Organization into so few dimensions imposes severe restrictions on permissible sounds. In the terminology of information theory, it reduces amount of information (or uncertainty) in speech systems, making them easier to learn.

Looking at phonemic organization from another viewpoint, the segmental phonemes of all languages have many similarities among themselves. Our own sounds for /d-t/ or /g-k/, for example, have the same manner and place of articulation.

Except in one alphabet, Korean Hangul, the corresponding letters of alphabets do not reflect these similarities—these reductions in what needs to be learned. Hangul does. If Korean phonemes sound alike, their letters look alike. Hangul was designed by scholars of King Sejong in 1446, and unlike all other alphabets, its letters were designed to parallel its spoken phonemes.

Korean phonemes that sound like our /d-t/ have letters that do look alike, C-E.* The extra-in the letter, E, stands for the extra aspiration in its sound, and predictably, letters for other sounds that are aspirated, also have the-.

*To help in distinguishing letters from sounds, printed letters are in bold. So are exemplars when the printed shape is more important than the sound.

Equally important, vowel letters are distinguishable from consonant letters, which permits simple visual-motor rules for spelling Korean syllables.

The Korean alphabet was designed in the fifteenth century by a royal commission appointed by King Sejong, who wished to bring the benefits of literacy to all his subjects. The product of their labors, “Hunmin-jongum” (Correct pronunciation of letters for teaching ordinary people) applied several principles so insightful that—with the 20-20 vision of hindsight—one wonders why none of them ever surfaced in the design of many hundreds of other writing systems throughout the 5000-year history of written language. Reference. Ledyard, G. K. (1966). The Korean language reform of 1446: The origin, background, and early history of the Korean alphabet. Unpublished Ph. D. dissertation, University of California, Berkeley.

In describing this alphabet and how its phonemic organization reduces the time required to learn it, a fifteenth century scholar remarked that “the bright can learn to read in a single morning, and even the not so bright in 10 days.” Modern linguists are no less complimentary about how phonemic organization reduces learning time. Grant remarked that “the Korean alphabet is so simple that it can be learned in minutes.” Reference. Grant, B. K. (1969) A guide to Korean characters (Reading and writing Hangul and Hanja). Elizabeth, N. J. and Seoul, Korea: Hollhm International, 1979.

In the terminology of information theory, the insightful dimensions into which Hangul letters are organized reduces the amount of information Korean Kindergarteners need to learn to a small fraction of the amount required to read and write in other alphabets. Instead of 26 different letters, they need learn only five according to the Korean definition of basic letter shapes.

It's centuries too late to create an English alphabet that can teach even a bright person “to read in a single morning.” However, if Hangul principles were applied to a keyboard attached to a speech synthesizer, learning to read and write in English (narrowly, learning to find the key for any enunciated phoneme) might require even less time than learning to read and write in Korean. An experimental psychologist—though less gifted with creative insight—hopefully knows more about the advantages of visual over auditory memory than did the scholars of fifteenth century Korea.

(B) Spelling Irregularity and the Initial Teaching Alphabet. Most of our problems in spelling are caused by trying to handle roughly 40 sounds with something less than 26 letters. (Why less than 26 letters? Because a few letters (e.g., c, q, x) duplicate the sounds of other letters.) More specifically, most of our problems are caused by trying to get by with five vowel letters to handle three times that many vowel sounds.

The solution to its shortage of vowel letters that English has used for centuries is to use silent markers such as the silent e to change vowel letters from short to long. Unfortunately, although only one silent marker was needed, English ended up with four common ones, e, a, i, y. Worse, they never got marked as silent markers. There's no way for a Kindergartener to tell when e, a, i, or y is an ordinary letter that signals a sound (macrame, deactivate, toil, beyond) and when it only signals that another vowel is to change from short to long (same, seal, sail, say).

Another solution to the shortage of letters, the one followed by the ITA (the Initial Teaching Alphabet), is to invent new letters, especially for the long vowels, diphthongs, and the sounds for /ch, sh/ and for the voiced and unvoiced /th/. The ITA invented no less than 23 new letters, including new letters for both the voiced and unvoiced /th/. The ITA succeeds well enough in reducing the irregularities of English spelling, but although it was widely tested in the United States and even more widely in England, the ITA didn't catch on. Why? Because 23 new letters are much too much—too much extra to learn, and worse, too much extra to forget or repress when the child reads ordinary print. In brief, 23 new letters made print look too strange—too much like a foreign language printed in a foreign alphabet. Reference. Downing, J. A. The initial teaching alphabet: Reading experiment. Chicago: Scott, Foresman, 1965.

So my keyboard doesn't even try to reduce spelling irregularity to the extent of the ITA. By using a tiny percentage of less radical changes, it makes almost no changes in the shapes of printed words. It continues the age-old tradition of long vowels vs. short vowels. Long vowels don't require much extra learning anyway. Children already know them; the long sound of a vowel is its name.

(C) Most Frequently Confused Letters. The most frequently confused letters are b with d, p with q, and i with l. Trifling changes that would require almost zero extra learning can remove them almost entirely. (a) Printing b to resemble its capital ( [symbol] ) essentially eliminates its tendency to be confused with d and p. (b) Printing qu as a ligature (qu) essentially eliminates q's tendency to be confused with d, b, p. And q is always followed by u except in a few Semitic borrowings, like qoph and Iraqi. (c) Printing l as something like its capital (L) makes it easier to distinguish from i. Enlarging the dot on i ( [symbol] ) further increases the difference (L [symbol] ).

(D) Lengthening Upward and Downward Protrusions on letters like d, h, g, y makes the outer contour of word shapes more distinguishable from one another. Note how this would increase the difference between the contours of one and toy, for example.

### BRIEF SUMMARY OF THE INVENTION

### A Phonemically Arranged Keyboard

### (A 64% Reduction of FIG. 1)

| | | | | | | | | | | | | |
|---|---|---|---|---|---|---|---|---|---|---|---|---|
| oo | oi | ou | au | w | g | k | | o | e | a | u | i |
| | b | p | | v | f | m | w | | a | e | i* | |
| | d | t | | z | s | n | y | | j | ch | th | sh |
| | g | c | k | l | r | | h | | | qu | | x |

*The letter marked i* is actually the Silent Marker, i-y. Silent Markers could be marked by color instead of being in outline. For example, in the middle of a word, the keyboard would be programmed to add a gray i behind a (as in maid or paid). But at the end of a word, the board would be programmed to substitute a gray y as in may or pay. Silent Markers in English change vowels from short to long, e.g., the silent e in same. There would be similar programming for the diphthong letters oi, ou, au. At the end of a word: oi becomes oy (coil-coy), ou becomes ow (south sow), au becomes aw (Saul-saw).

The most important claim of my invention is re-arranging the keys to parallel the dimensions that distinguish English phonemes. This would reduce a Kindergartener's problems in learning to find the key for any enunciated phoneme. The 556-year history of Hangul predicts that phonemic arrangement would reduce the time required to learn the sounds of the letters, which would reduce time required to learn the first-year fundamentals of reading and writing (or typing).

FIG. 1 plus the title would seem to satisfy most of the requirements of disclosure. Almost any programmer could re-program a keyboard to conform to FIG. 1's phonemic organization. Almost any teacher of phonics could use the machine to teach a child the sounds of the letters. Almost any 5-year-old could use the machine to teach herself the sounds of the letters. She'd type a key; the synthesizer would say its sound.

Speech synthesizers have been attached to keyboards before, but my keyboard makes five new contributions enumerated under CLAIMS, Page 13.

### BRIEF DESCRIPTION OF THE ONE DRAWING

FIG. 1 does no more than enlarge the above phonemic arrangement of the keyboard. Note that, if future experiments with the keyboard showed it to be desirable, letters for vowels (including diphthongs), silent markers (a e i-y), and consonants could be further differentiated by using different shaped keys for the three. I did not use color in FIG. 1, but obviously it would be easy to differentiate the three categories still further by having their keys in different colors. Moreover, it would be easy to use color to differentiate the consonants into phonemic or spelling categories—stops, fricatives, nasals, glides, th-sh-ch, etc.

### DETAILED DESCRIPTION OF THE INVENTION

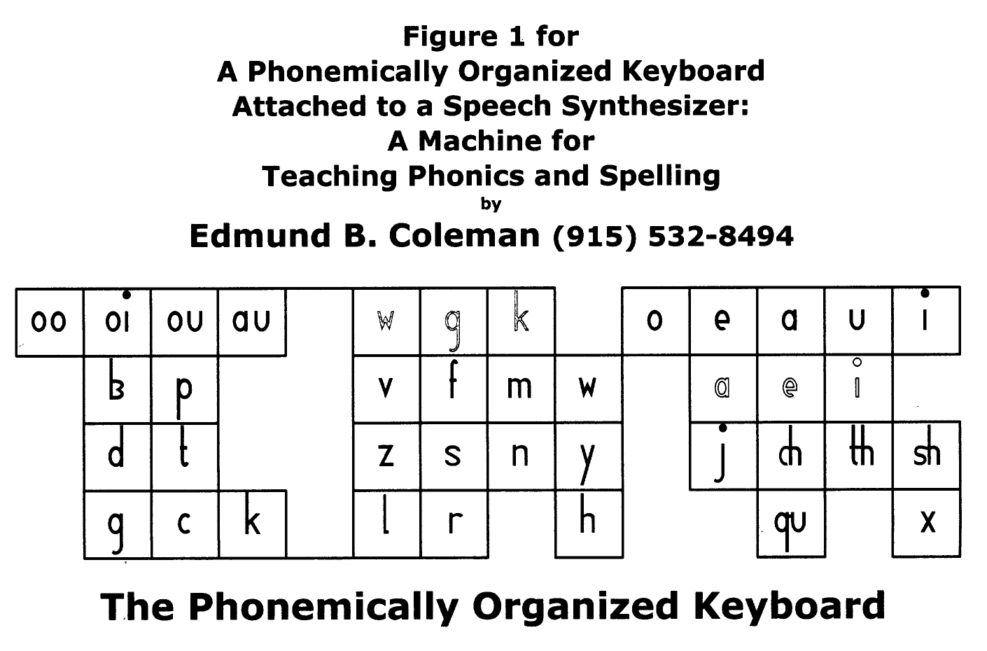

The BRIEF SUMMARY OF THE INVENTION, plus FIG. 1, would seem to satisfy most of the requirements of disclosure. Namely, they are “sufficient so that” any computer programmer “could make and use the invention without extensive experimentation.”

There are two ways to actually construct a Phonemically Organized Keyboard: (A) Re-programming and (B) Hard Wiring.

(A) Re-programming. For small numbers, a program to reprogram keys of an existing board to conform to FIG. 1 would be more economical. Even I (and I certainly wouldn't hire me as a programmer) used to be able to write an elementary version of such a program in Apple Basic. I would have ten or twelve new keys manufactured, and there are companies that do this.

(B) Hard-Wiring. When I decided to go into mass production and sales, I would arrange with a manufacturer of keyboards to have his keys hard-wired to conform to FIG. 1. It's probable that most, if not all, manufacturers employ programmer-technicians who can hard-wire keys in this arrangement. The manufacturer could also reduce the number of keys, enlarge them, and separate them to better suit a child's learning the sounds of the letters.

Specifics of Keyboard Design: In the Korean alphabet, phonemes that are pronounced alike have letters that look alike (as the pair of letters, C-E). It would be equally effective to place the letters of phoneme pairs adjacent to one another as illustrated in FIG. 1. In the Korean alphabet, the shape of the letter suggests the placement of the articulators when pronouncing the phoneme; the letter's placement on the keyboard can do so more effectively. In FIG. 1, for example, letters for voiced and unvoiced stops ( [symbol] , d-t, g-ck) are paired and sequenced down the keyboard as to whether their phonemes are pronounced by the front, middle, or back of the mouth. In Hangul, vowel letters are distinguished from consonant letters by different shapes; a child could differentiate the two far more easily if they were positioned as upper keys vs. lower keys.

Specifics for Teaching Children. The child would be taught the articulatory dimensions that distinguish English phonemes. And he would be taught that the arrangement of letter-keys parallels articulatory dimensions. He would be taught that the phoneme pairs /b-p, d-t, g-k/ are articulated with tongue and lips in the same positions. He would also be taught that the articulators move from front to back in the sequences /b-d-g, p-t-k/. He would pronounce the phonemes, consciously feeling the position of his articulators, and then move letter-cards into the same arrangement as their letter-keys.

My organized keyboard should reduce the time a child requires to learn the sounds of the letters. This learning task is a joint visual-phonological task, and my keyboard—like Hangul—sets visual and phonological dimensions in parallel so that the two dimensions reinforce one another. The auditory and articulatory dimensions of speech, already long-practiced and familiar, would help the child learn the parallel dimensions of the keyboard.

More important, the visual dimensions of the keyboard, because they are more accessible to working memory, would reinforce auditory and articulatory dimensions. It is much easier to induce conceptual relations between keys that are seen than between sounds that are heard.

Why? Because of several advantages of printed language, which is permanent, over spoken language, which is not. (1) One advantage of inducing a visual concept over inducing an auditory concept is that vision is not limited by the transitory nature of the brain's auditory stimulus register, echoic memory. Much of an auditory stimulus disappears from working memory in 3 or 4 seconds as echoic memory decays. A keyboard on the other hand is continuously in view; the visual pattern is continuously being restored to working memory.

(2) There is a second reason why it is easier to induce relations between keys that are seen than between sounds that are heard. It is difficult (if not impossible) to arrange auditory stimuli along more than a single dimension, time. For example, the dimensions of the consonant phonemes (front-to-back, voiced-unvoiced, and mode of articulation) can be presented auditorily only by pronouncing phonemes one after another: /p,t,k/ or /b,d,g/ or /p-b, t-d, k-g/, etc. Their visual letters, however, can be simultaneously, continuously, displayed along two dimensions.

In fact, if future experimentation with children showed that it would facilitate learning, the keyboard could use additional dimensions such as color, size, shape, and feel. For example, the vowel keys could be white (as well as being at the top of the keyboard). And the consonant keys could be colored. Perhaps different colors for stops, fricatives, nasals, glides, etc. The point? A keyboard has an abundant excess of visual dimensions to differentiate phonic and spelling categories.

Facilitating Memory. From the viewpoint of facilitating memory, a phonemically organized keyboard would be presenting each articulatory characteristic in an extra, parallel dimension, increasing its opportunities for storage in and retrieval from memory.

Handling Concepts. From the viewpoint of facilitating the induction and manipulation of concepts, my keyboard would be using visual dimensions to categorize what the child hears as a huge mishmash of unrelated auditory units into a tiny handful of visual categories. (A preliterate child cannot categorize the phonemes /a,d,e,g,i,t,o,h,i,r,n/ into consonants versus vowels, but s/he can instantly categorize their letters on my organized board into lower keys versus upper keys).

As spelling requirements become greater, facilitation from visual categories would inevitably become greater. It would be possible to code the spelling formula for say a CVC syllable (Consonant-Vowel-Consonant syllable like cat) as a simple visual-motor formula: “Type a lower key; then an upper key; then a lower key.” For whatever physiological or psychological reasons, even an accomplished phonetic specialist would find it difficult to verbalize the auditory or articulatory correlate of that simple formula, and still more difficult to translate simple visual-motor formulas for consonant clusters as in brat or pant. Not to mention strands (lower, lower, lower, upper, lower, lower, lower).

Since there is an abundance of visual dimensions yet to be used, once low-cost versions of my keyboard are available for wide experimentation with children, improvements in the future are as inevitable as the incoming tide. Since a keyboard has more than enough keys to accommodate all segmental phonemes, it can ameliorate the basic problem of the English alphabet: Roughly 40 phonemes must be represented by less than 26 letters. Since keyboards have more than 40 keys, many irregular spelling rules can be stored in the keyboard to parallel rules in the child's memory.

speech synthesizers have been attached to keyboards before, but my keyboard makes five new contributions, which are my five claims:

1. The letters of my keyboard are positioned (see FIG. 1) so their arrangement depicts phonemic dimensions; i.e., phonemes that are articulated similarly, or have similar functions in spelling, are in adjacent keys, which are sequenced along the keyboard to indicate place of articulation (front-middle-back of mouth).

2. My board has letter-keys for diphthongs (oo, oi, ou, au) that do not have their own separate letters, and moreover, the keys are programmed to print both letters, and to change oi, ou, au into oy, ow, aw respectively when they are not inside a word but at its end.

3. It has letter-keys for phonemes spelled with h (ch, sh, th).

4. It has letter-keys for silent markers (a, e, i-y), and moreover, the keys are programmed to print silent markers as dotted, or in outline, or in different colors or sizes, or to similarly differentiate them from ordinary letters that signal sounds, e.g., bead, need, maid, may.

5. To reduce the most frequent confusions among letters (confusions among b-d-p-q and i-l), four slight changes are made: b, q, I, i become b, qu, L, I.
